(19) United States
(12) Patent Application Publication
(10) Pub. No.: US 2024/0154901 A1
(43) Pub. Date: May 9, 2024

(54) METHODS, APPARATUSES AND SYSTEMS DIRECTED TO SERVICE ROUTING ON A USER PLANE OF A COMMUNICATIONS SYSTEM

(71) Applicant: InterDigital Patent Holdings, Inc., Wilmington, DE (US)

(72) Inventors: Sebastian Robitzsch, London (GB); Ulises Olvera-Hernandez, Saint-Lazare (CA); Kay Hansge, Berlin (DE)

(21) Appl. No.: 18/280,612

(22) PCT Filed: Mar. 7, 2022
(86) PCT No.: PCT/US2022/019147

§ 371 Date: Sep. 6, 2023

(30) Foreign Application Priority Data
Mar. 8, 2021 (EP) 21161381.5

(51) Int. Cl. H04L 45/302; H04W 40/02

(52) U.S. Cl. CPC H04L 45/306; H04W 40/02

(57) ABSTRACT

A method, implemented by a wireless transmit/receive unit, WTRU, includes receiving, a first message including information indicating a control plane procedure. According to the control plane procedure, a second message including a publish request is transmitted to a network node. Responsive to the publish request, a third message including information indicating a packet path routing indication is received from the network node. A fourth message, including uplink data, according to the packet path routing indication is transmitted to a data network.

### CROSS-REFERENCE TO RELATED APPLICATIONS

This application claims the benefit of EP Patent Application No. 21161381.5, filed Mar. 8, 2021, the entire disclosure of which is incorporated herein by reference.

### BACKGROUND

The present disclosure relates to network communications, including, but not exclusively, to methods, apparatuses, systems, etc. directed to service routing on a user plane of a communications system.

### BRIEF SUMMARY

According to an embodiment, a method, implemented by a wireless transmit/receive unit, WTRU, includes receiving, a first message including information indicating a control plane procedure. According to the control plane procedure, a second message including a publish request is transmitted to a network node. Responsive to the publish request, a third message including information indicating a packet path routing indication is received from the network node. A fourth message, including uplink data, according to the packet path routing indication is transmitted to a data network.

According to an embodiment a wireless transmit/receive unit, WTRU, comprises a processor and a non-transitory computer-readable storage medium storing instructions operative, when executed by the processor, to receive, a first message including information indicating a control plane procedure. According to the control plane procedure, a second message including a publish request is transmitted to a network node. Responsive to the publish request, a third message including information indicating a packet path routing indication is received from the network node. A fourth message, including uplink data, according to the packet path routing indication is transmitted to a data network.

Although various embodiments are described and/or claimed herein in which an apparatus, system, device, etc. and/or any element thereof is configured to carry out an operation, process, algorithm, function, etc. and/or any portion thereof, it is to be understood that any embodiments described and/or claimed herein assume that any apparatus, system, device, etc. and/or any element thereof carries out any operation, process, algorithm, function, etc. and/or any portion thereof (and vice versa).

### BRIEF DESCRIPTION OF THE DRAWINGS

A more detailed understanding may be had from the following description, given by way of example in conjunction with the accompanying drawings. Figures in such drawings, like the detailed description, are examples. As such, the Figures and the detailed description are not to be considered limiting, and other equally effective examples are possible and likely. Furthermore, like reference numerals in the figures indicate like elements. In the drawings:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example of a RAN and a further example of a CN that may be used within the communications system illustrated in FIG. 1A according to an embodiment;

FIG. 2 is a block diagram illustrating a communications system configured as a conventional 5G system (5GS);

FIG. 3 depicts an example architecture of a system configured to carry out name-based routing (NbR);

FIG. 4 is a block diagram illustrating an example of a name-based routing architecture on the user plane, according to an infrastructure mode embodiment;

FIG. 5 is a diagram illustrating an example of NbR user plane protocol stack for infrastructure mode for both PDU session types IP and IEEE 802.3. according to an embodiment;

FIG. 6 is a sequence diagram illustrating an example of a session management function (SMF) and a user plane function (UPF) provisioning according to an embodiment;

FIG. 7 is a sequence diagram illustrating an example of a registration of vertical application against NbR UPF according to an embodiment;

FIG. 8 is a sequence diagram illustrating an example of a session establishment for NbR UPFs operating in infrastructure mode according to an embodiment;

FIG. 9 is a block diagram illustrating an example of a name-based routing system architecture on the user plane, according to a WTRU mode embodiment;

FIG. 10 is a diagram illustrating an example of NbR user plane protocol stack for WTRU mode over IEEE 802.3. according to an embodiment;

FIG. 11 is a sequence diagram illustrating an example of a session establishment for NbR UPFs operating in WTRU mode according to an embodiment; and

FIG. 12 is a flow chart illustrating an example of a method for a session establishment for NbR UPFs operating in WTRU mode according to an embodiment.

### DETAILED DESCRIPTION

A detailed description of illustrative embodiments will now be described with reference to the various figures. Although this description provides a detailed example of possible implementations, it should be noted that the details are intended to be exemplary and in no way limit the scope of the application. In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein.

### Example Communications Networks

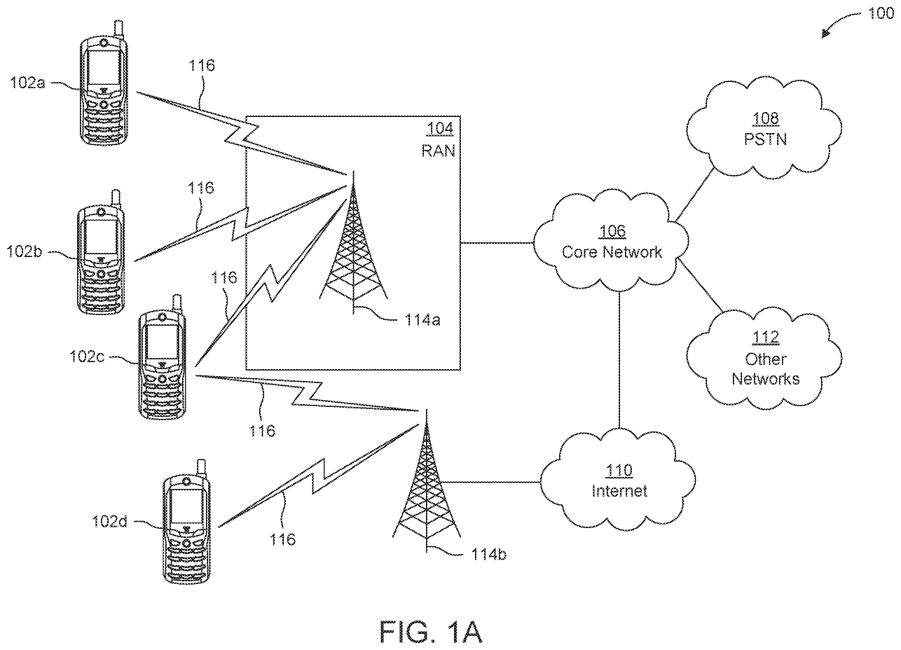

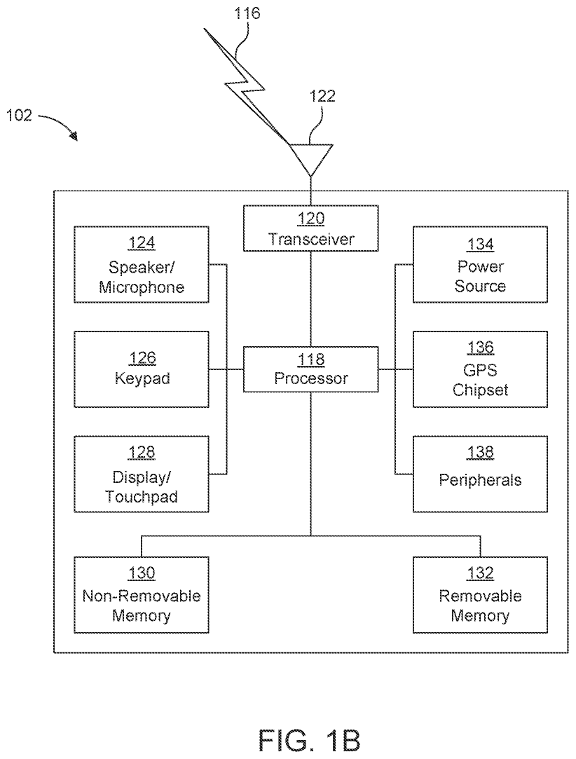

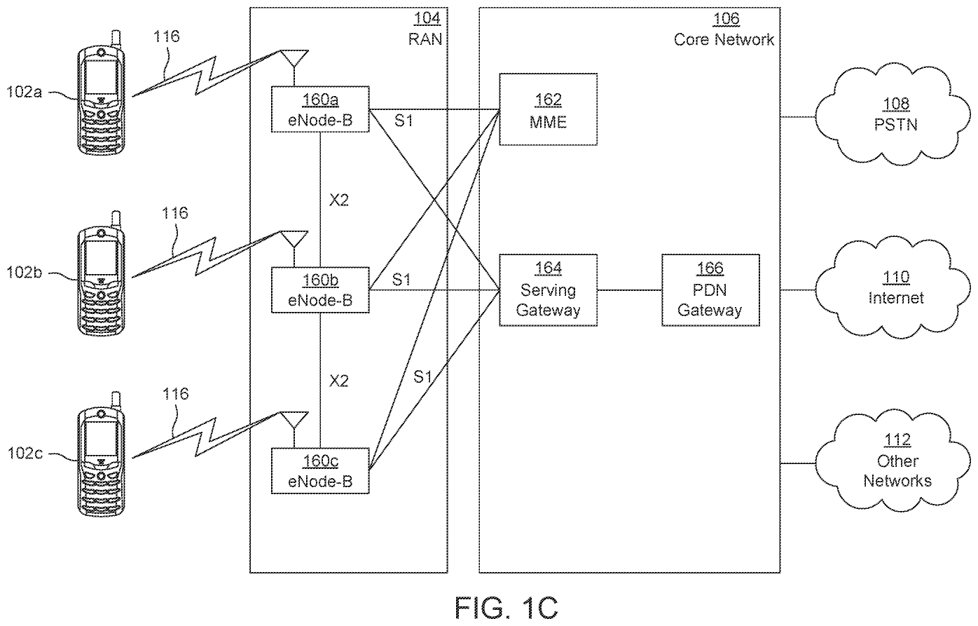

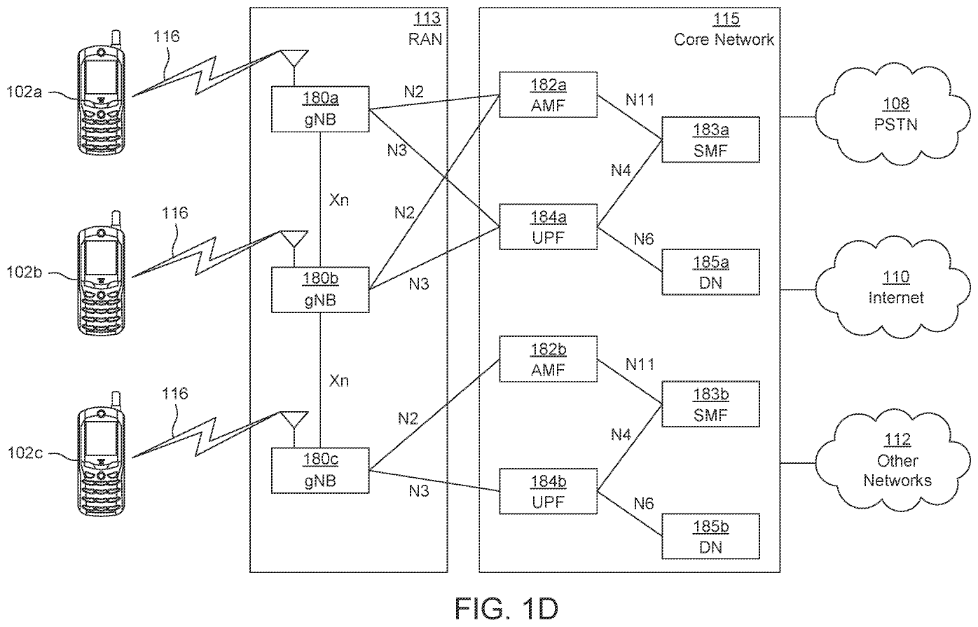

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a Radio Access Network (RAN) 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or an “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, an NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as universal mobile telecommunications system (UMTS) terrestrial radio access (UTRA), which may establish the air interface 116 using wideband CDMA (WCDMA). WCDMA may include communication protocols such as high-speed packet access (HSPA) and/or evolved HSPA (HSPA+). HSPA may include high-speed downlink (DL) packet access (HSDPA) and/or high-speed UL packet access (HSUPA).

In an embodiment, the base station 114a and the WTRUs 102a, 102b, 102c may implement a radio technology such as evolved UMTS terrestrial radio access (E-UTRA), which may establish the air interface 116 using long term evolution (LTE) and/or LTE-advanced (LTE-A) and/or LTE-advanced pro (LTE-A Pro).

In an embodiment, the base station 114a and the WTRUs 102a, 102b, 102c may implement a radio technology such as NR radio access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (e.g., wireless fidelity (WiFi), IEEE 802.16 (i.e., worldwide interoperability for microwave access (WiMAX)), CDMA2000, CDMA2000 1×, CDMA2000 EV-DO, interim standard 2000 (IS-2000), interim standard 95 (IS-95), interim standard 856 (IS-856), global system for mobile communications (GSM), enhanced data rates for GSM evolution (EDGE), GSM EDGE (GERAN), and the like.

The base station 114b in FIG. 1A may be a wireless router, home node B, home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special-purpose processor, a conventional processor, a digital signal processor (DSP), a plurality of microprocessors, one or more microprocessors in association with a DSP core, a controller, a microcontroller, application specific integrated circuits (ASICs), field programmable gate arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full-duplex radio for which transmission and reception of some or all of the signals (e.g., associated with particular subframes for both the UL (e.g., for transmission) and downlink (e.g., for reception) may be concurrent and/or simultaneous. The full-duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 megahertz (MHz) wide bandwidth) or a dynamically set width via signaling. The primary channel may be the operating channel of the BSS and may be used by the STAs to establish a connection with the AP. In certain representative embodiments, carrier sense multiple access with collision avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing and time domain processing may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 gigahertz (GHz) modes of operation are supported by 802.11af and 802.11ah. The channel operating bandwidths, and carriers, are reduced in 802.11af and 802.11ah relative to those used in 802.11n, and 802.11ac. 802.11af supports 5 megahertz (MHz), 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by an STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to an STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement coordinated multi-point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane function (UPF) 184a, 184b, routing of control plane information towards access control and mobility management function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one session management function (SMF) 183a, 183b, and possibly a data network (DN) 185a, 185b. While each of the foregoing elements is depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented or deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented or deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

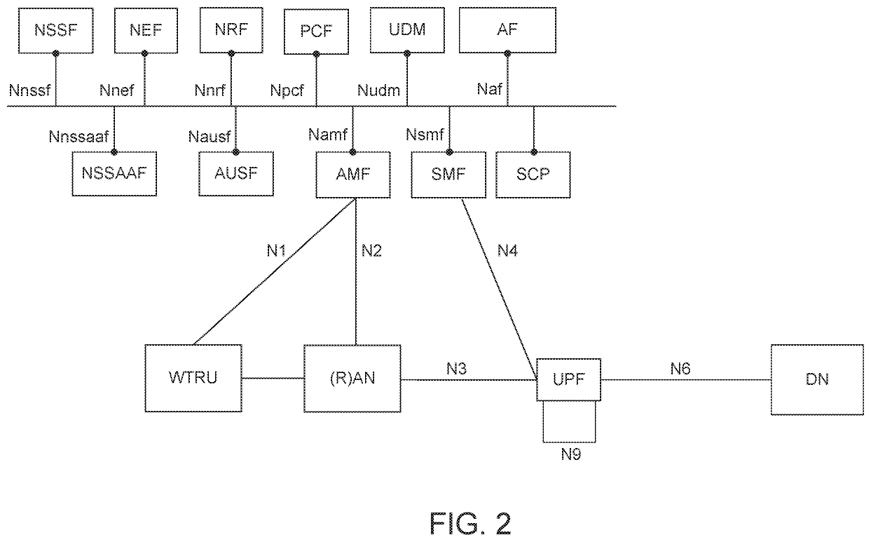

FIG. 2 is a block diagram illustrating a communications system configured (at least in part) as a (e.g., 3GPP defined) conventional 5G system (5GS). The conventional 5GS may include a RAN and a CN. One of design principles for the architecture of the 5GS is service-centric or service-based. The CN may include various network functions (NFs). The NFs may work together to fulfil and/or provide services to the RAN, a WTRU and/or an application server/service provider. The network functions may include a network slice selection function (NSSF), a network exposure function (NEF), a network repository function (NRF), a policy control function (PCF), a unified data management (UDM), an application function (AF), a NSSAAF, an authentication server function (AUSF), an access and mobility management function (AMF), a session management function (SMF), a service communication proxy (SCP), a user plane function (UPF), and others (not shown).

The NSSF, NEF, NRF, PCF, UDM, AF, NSSAAF, AUSF, AMF, SMF and other AFs (not shown) may offer service-based interfaces (SBIs) (as indicated by the circle interconnected with their respective interface lines). The SBIs may enable representational state transfer (RESTful) communications between consumers and servers. In the conventional 5GS, communications between the SMF and the UPF do not occur via SBIs (unlike other AFs in which the SCP may be used to reach each other). Instead, as shown, the SMF and the UPF may communicate via an N4 interface (or reference point).

In the conventional 5GS, single UPF and distributed UPF operations are allowed. For both, communication between a UPF and an SMF via the N4 interface may be manually configured. Either the UPF or the SMF may initiate an association setup. As an example, information identifying one or more available UPFs (“a list of available UPFs”) may be manually added to the NRF, and an SMF may retrieve the list of available UPFs via an SBI of the NRF (e.g., Nnrf). If more than one UPF is available to an SMF, a UPF selection procedure for a specific PDU session may be carried out as part of a PDU session establishment procedure within the SMF.

As shown in FIG. 2, the UPFs and DNs may communicate via respective N6 interfaces (reference points). Information, such as traffic routing information for the N6 interfaces, may be obtained by (provided to) the AF. The AF may provide the traffic routing information and/or other information to the SMF. The SMF may use that information to determine which of the available UPFs to select.

Pre-configuration and customization of a (e.g., 5G) communication system may be intended to increase system efficiency, to e.g., execute node level operation and management (O&M) procedures to define virtual links. Said pre-configuration and customization of a 5G communication may not allow the system to discover system components, and route messages using cloud-based principles. For example, AMFs and NG-RAN nodes may be setup through a configuration procedure, e.g., linking a (e.g., given) gNB with a (e.g., given) AMF entity. The provisioning of 5G core (5GC) network functions (NFs), e.g., the SMF and UPF, may be manually conducted such that flexibility and extensibility of the 5G communication system may be reduced.

The 5G communication system may be based on the establishment of “data pipes” anchored to specific (e.g., given) network entities, such as the user plane function (UPF), which once set up, may be used to transport data from a WTRU to the edge of the network or from WTRU to WTRU. These “data pipes”, referred to herein as PDU sessions, may be controlled by the 5GC which may include a set of dedicated (e.g., given) NFs. Said NFs may be responsible for establishing, maintaining, tearing down PDU sessions, according to operator polices.

Mobile communications are in continuous evolution and are already at doorsteps of its fifth incarnation, which is called 5^{th} generation (5G). A CN (e.g., a 5GC) of a communication system may include one or more NFs and/or one or more interfaces to support service routing on the user plane. A name-based routing (NbR) system may utilise information-centric networking (ICN) semantics to perform service routing for hypertext transfer protocol (HTTP) endpoints and support internet protocol (IP) based communication.

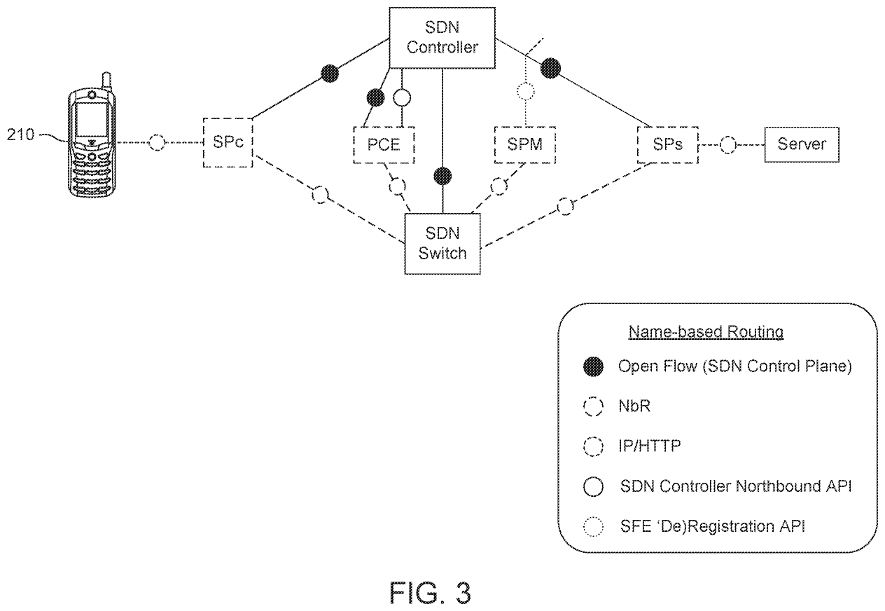

FIG. 3 depicts an example architecture of a system configured to carry out name-based routing (NbR) (herein “NbR system”). The NbR system may include various software-defined networking (SDN) components, NbR components, and user plane components. The NbR system may include various other elements, components, etc. (not shown).

The user plane components may include a plurality of endpoints; each of which may operate as both a client and a server. In its role of a client, an endpoint may initiate a transaction according the internet protocol (IP) or other protocol above a network access layer (e.g., above an Ethernet protocol) (hereinafter “IP endpoint”). In its role of a server, the endpoint may listen on a transport layer port for an incoming transaction, service the transaction and/or reply with another transaction (hereinafter “IP-service endpoint”).

The SDN components may include an SDN controller and an SDN switch. The SDN controller may configure the SDN switch for NbR using an SDN protocol, such as OpenFlow. The SDN controller may be, for example, any of an OpenDaylight controller, a Floodlight controller and an Open Network Operating System (ONOS®) controller. The SDN switch may forward communications from the IP endpoint and the IP-service endpoint (and vice versa) using NbR.

The NbR components may include any of a service proxy (SP), a path computation element (PCE) and a service proxy manager (SPM). The SP may perform protocol translation. The SP, for example, may translate between an internet protocol (IP) information-centric networking (ICN). The PCE may perform any of publishing/subscribing and path calculation tasks for inter SP communications.

The SPM may be a logically centralised component, may manage the configurations for SPs, and may include an interface for registration/deregistration of fully qualified domain name (FQDN) based service endpoints.

The PCE may acts as a northbound application to the SDN controller for topology management and rules injection purposes. The SPs may (e.g., semantically) load or otherwise revise the IP header with its forwarding identifiers (FIDs) for path-based packet forwarding. The SDN controller may configure arbitrary bitmask matching fields of a forwarding table in the SDN switch (or there SDN switches (not shown)) for handling the FIDs.

### Example of Name-Based-Routing Infrastructure Mode

NbR may be carried out in an infrastructure mode. In the infrastructure mode, UPFs may be able to communicate among each other, e.g., via a N9′ interface for various NbR procedures. Other interfaces not involved with NbR communications with a UPF, e.g., N3, N6 and N19 interfaces, are left unchanged.

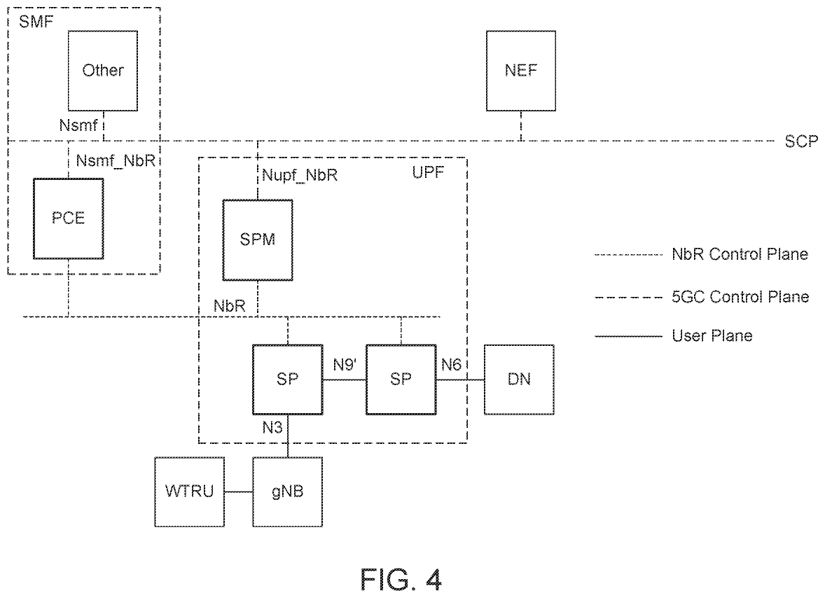

FIG. 4 is a system diagram illustrating examples of an SMF and an UPF of a CN (e.g., 5GC) according to an embodiment. The SMF may include a PCE and one or more other functions. The PCE and other functions may be communicatively coupled to a control plane (e.g., a 5GC control plane) via respective SBIs. The PCE, for example, may be communicatively coupled to the control plane via an SBI (a dedicated SBI) configured for NbR (herein “Nsmf NbR interface”). The PCE may be responsible for rendezvous and forwarding identifier (FID) calculation functionality. Inclusion (or integration) of the PCE as a function of the SMF may allow any consumer (e.g., other functions of the SMF) to utilise the functionality provided by the PCE.

Although not shown, the UPF may communicatively couple to the control plane via an SBI, Nupf interface, which may allow any consumer (e.g., SMF) to communicate with the UPF. The UPF may include a SPM, a first SP and a second SP. The SPM may be communicatively coupled to the control plane via an SBI (a dedicated SBI) configured for NbR (herein “Nupf NbR interface”). The Nupf NbR interface may define various dedicated messages (e.g., Nupf primitives) to enable integration of NbR and/or enable NbR on the user plane.

Pursuant to the various embodiments disclosed herein, the Nupf interface has at least two advantages over a conventional N4 interface. Firstly, with CNs being configured (e.g., orchestrated) (automated deployment) in a cloud native fashion, post-configuration (e.g., post-orchestration) of point-to-point endpoints (e.g., SMF and UPF on N4) may become obsolete. The provisioning and communication towards the UPF may apply the same cloud native principles as the other CN NFs. Secondly, the Nupf interface may allow more than one NF to operate as a consumer and communicate with the UPF, thereby making any hard binding between two NFs from the CN unnecessary. As used herein, the inter UPF communication interface in which the NbR layer operates on top of IEEE 802.3 is denoted as N9′ to differentiate it from the N9 interface as communications over N9 are IP-based communications.

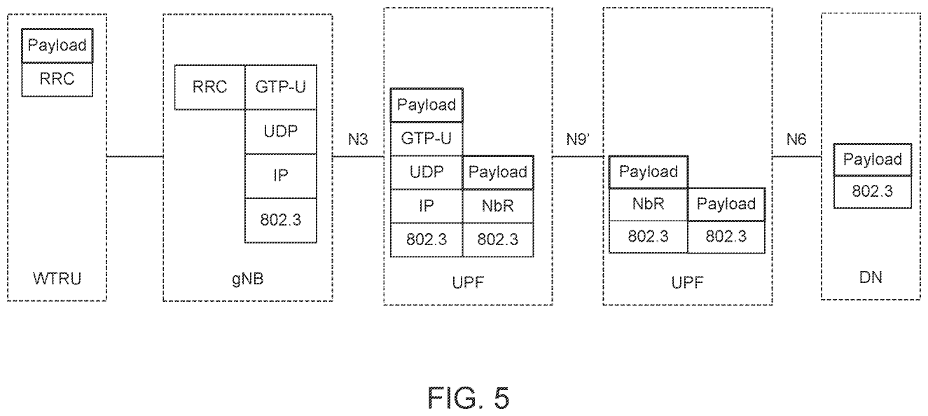

FIG. 5 depicts an example NbR user plane protocol stack for infrastructure mode. The protocol stack may include an NbR layer on top of 802.3 for the N9′ interface. A payload originating from any of a WTRU and a DN may be any of type IP and IEEE 802.3 (5G local area network (LAN)) and/or may be handled according to NbR specifications for HTTP and non-HTTP IP-based communication, such as that disclosed in US2020/0162573 and U.S. Pat. No. 10,554,553, respectively.

### Example of SMF and UPF Provisioning

The provisioning of SMF and UPF may be part of the automated deployment of a CN (e.g., aka orchestration), e.g., through an external technology, (e.g., OpenShift or Kubernetes integrated into ETSI MANO frameworks such as OpenSource Mano (OSM) or Open Network Automation Platform (ONAP)).

Current procedures to provision SMF and UPFs are of rather static nature even when involving the NRF for these purposes. With the introduction of service-based architecture (SBA) and the advances of cloud native software design and engineering, such static provisioning can be avoided.

The SBA may include non-static provisioning. Distributed UPF scenario may include SDN (e.g., OpenFlow), as illustrated by FIG. 3, that may contribute on topology management procedures (e.g., bootstrapping, link discovery and link failure detection).

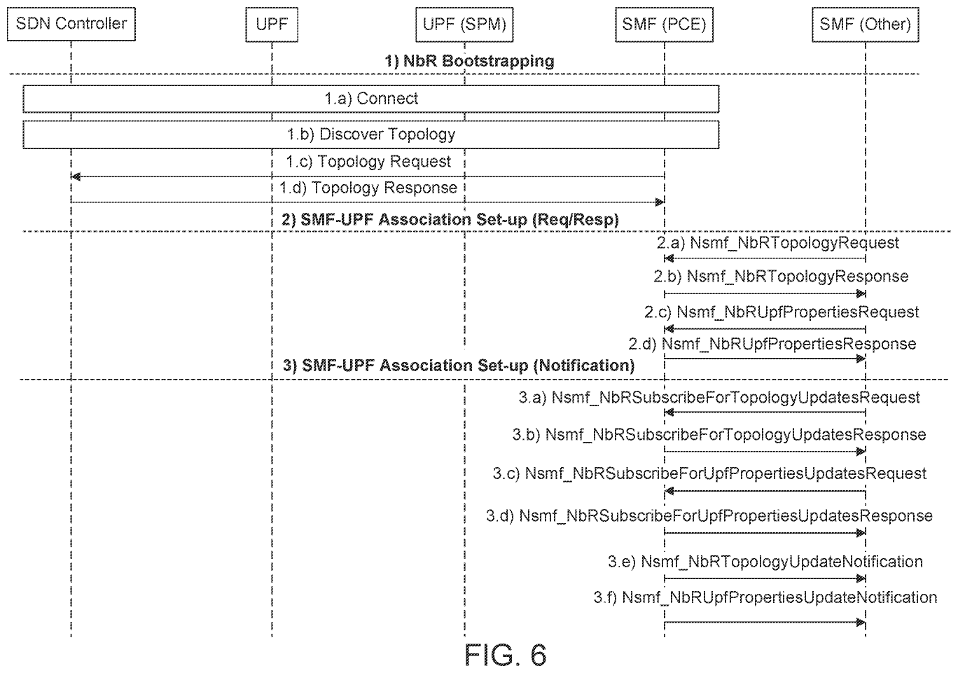

FIG. 6 depicts an example procedure for UPF topology management in a CN having a configuration in accordance with the NbR system architecture of FIG. 3. The procedure may be suitable for SMF and UPF provisioning.

According to Steps 1.a), 1.b), 1.c) and 1.d) of FIG. 6, any (e.g., all) NbR components may join an SDN switching structure and may form a topology.

According to Step 1.a), any (e.g., all) components connected to the NbR signalling plane, may connect to the SDN controller and may use (e.g., leverage) the SDN for their communication among each other.

According to Step 1.b), the SDN controller may request any (e.g., all) connected switches to discover their link-local neighbours via a link local discovery protocol (LLDP).

According to Step 1.c), the PCE may (e.g., repeatedly, periodically) send, to the SDN controller, a message including a topology request via its (e.g., northbound) application program interface (API).

According to Step 1.d), the SDN controller may send, to the PCE, a message including the known topology which may include switch identifiers and its neighbours among other information. As (e.g., northbound) APIs for SDN controllers may not be standardised, the information provided for each switch may vary but may always include switch identifier and its neighbours.

Steps 2.a), 2.b), 2.c) and 2.d) of FIG. 6, correspond to request-response communications between a producer (e.g., SMF-PCE as producer) and other consumers (e.g., SMF) via the Nsmf NbR interface.

According to Step 2.a), another (e.g., decomposed) consumer service (e.g., a SMF service) may send a topology request message (e.g., Nsmf_NbRTopologyRequest( ) message) to the producer (e.g., SMF-PCE) indicating a request of an updated topology of UPFs.

According to Step 2.b), the producer (e.g., SMF-PCE) receiving (e.g., serving) the request message of Step 2a), may send a topology response message (e.g., Nsmf_NbRTopologyResponse( ) message) to the other consumer (e.g., SMF) which may indicate a (e.g., full) topology. For example, any (e.g., only) UPFs that may implement the SP functionality and may serve any of N3, N6, N9′ and N19 interfaces may be returned in the topology response message (e.g., Nsmf_NbRTopologyResponse( ) message), as the NbR components PCE and SPM may not process user plane packets and may not include packet detection rules (PDRs).

According to Step 2.c), the other consumer (e.g., SMF) may send a properties request message (e.g., Nsmf_NbRUpfPropertiesRequest( ) message) to the producer (e.g., SMF-PCE) including a request of the properties of a particular switch.

According to Step 2.d), the producer (e.g., SMF-PCE) may send a properties response message (e.g., NsmfRUpfPropertiesResponse( ) message), to the other consumer (e.g., SMF), based on the request message of Step 2.c), which may include various properties for a (e.g., particular) switch ranging from port configurations. For example, the UPF properties may provide the other consumer (e.g., SMF) with the information which routing technology a particular UPF implements.

Steps 3.a), 3.b), 3.c), 3.d), 3.e) and 3.f) of FIG. 6 correspond to request-response communications between a producer (e.g., SMF-PCE as producer) and other consumers (e.g., SMF) via the Nsmf NbR interface.

According to Step 3.a), another consumer (e.g., SMF) may transmit, to the producer (e.g., SMF-PCE), a topology updates request message (e.g., Nsmf_NbRSubscribeForTopologyUpdatesRequest( ) message) that may indicate how to communicate updates of topology.

According to Step 3b), the producer (e.g., SMF-PCE) may transmit, to the other consumer (e.g., SMF), a topology updates response message (e.g., Nsmf_NbRSubscribeForTopologyUpdatesResponse( ) message) that may indicate a status confirmation of the notification registration of Step 3.a).

According to Step 3.c), the other consumer (e.g., SMF) may transmit, to the producer (e.g., SMF-PCE), a properties update request message (e.g., Nsmf_NbRSubscribeForUpfPropertiesUpdatesRequest( ) message) that may indicate a request to subscribe to future updates on any property changes for a (e.g., given, particular) UPF (e.g., SDN switch) from the set of UPFs (SDN switches) communicated in the topology.

According to Step 3.d), the producer (e.g., SMF-PCE) may transmit, to the other consumer (e.g., SMF), a properties update response message (e.g., Nsmf_NbRSubscribeForUpfPropertiesUpdatesResponse( ) message) that may indicate a status confirmation of the notification registration of Step 3.c).

According to Step 3.e), if there is a topology update, the producer (e.g., SM-PCE) may review (e.g. go through) the list of subscribers to topology information and may transmit a notification to the other consumer (e.g., SMF), via a topology update notification message (e.g., Nsmf_NbRTopologyUpdateNotification( ).

According to Step 3.f), if there is an update of the properties of a UPF, the producer (e.g., SMF-PCE) may review (e.g., go through) the list of subscribers to UPF property updates and may transmit a notification to the other consumer (e.g., SMF), via a properties update notification message (e.g., Nsmf_NbRUpfPropertiesUpdateNotification( ).

According to the Steps 1.x), and to any of Steps 2.x) and 3.x) of FIG. 6, the producer (e.g., SMF-PCE) may have any (e.g., all) information for determining PDRs for future session requests by WTRUs.

### Example of Registration of Vertical Application Against NbR UPF

The NbR system may (e.g., in a CN having a configuration in accordance with the integrated NbR system architecture of FIG. 5) provide (e.g., transparent) service routing capabilities for stateless protocols, e.g., HTTP, and may allow the switch of service endpoints (e.g., server) without affecting the endpoint (e.g., WTRU, client). In such case, the NbR layer applying the routing decisions as an UPF, may include the information where service endpoints are located.

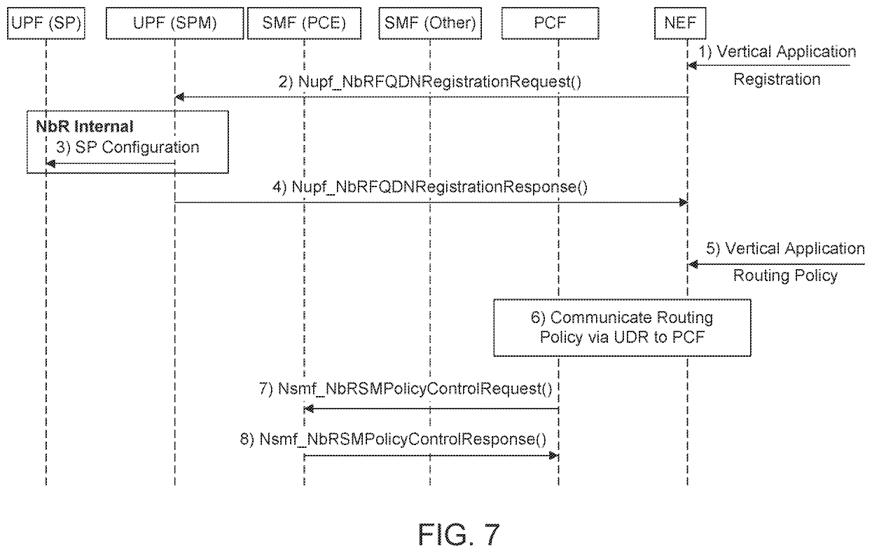

FIG. 7 is an example of a message exchange in connection with a registration of vertical application (e.g., located in a DN) against NbR-based UPFs.

According to Step 1), the NEF may receive, from an AF, a message including information about the existence of a new vertical application in a particular DN.

According to Step 2), the NEF may transmit, to the UPF-SPM, over the service interface (e.g., Nupf), a registration request message (e.g., Nupf_NbRFQDNRegistrationRequest( ) message) that may indicate the existence of the new vertical application.

According to Step 3), the UPF-SPM) may transmit the information across any (e.g., all) SPs (e.g., UPF-SP) that may implement the user plane packet routing functionality. This may be exchanged over the NbR internal pub/sub-based control plane.

According to Step 4), upon distributing the registration information, the UPF-SPM may transmit to the NEF (e.g., the consumer), a registration response message (e.g., Nupf_NbRFQDNRegistrationResponse( ) message) that may indicate a confirmation of the status of the registration of Step 2).

According to Step 5), the NEF may receive, from the AF, a message including information indicating a request for specific routing policy instructions.

According to Step 6), the NEF may transmit, to the PCF, via UDR and unified data management (UDF), the message of Step 5), such that PCF may determine the (e.g., appropriate) routing policy.

According to Step 7), the PCF may transmit, to the SMF-PCE, a policy control request message (e.g., Nsmf_NbRSMPolicyControlRequest( ) message) that may indicate the routing policy.

According to Step 8), the SMF-PCE may transmit, to the PCF, a policy control response (e.g., Nsmf_NbRSMPolicyControlResponse( ) message) that may indicate the processing state of the policy request.

### Example of Session Establishment for Infrastructure Mode

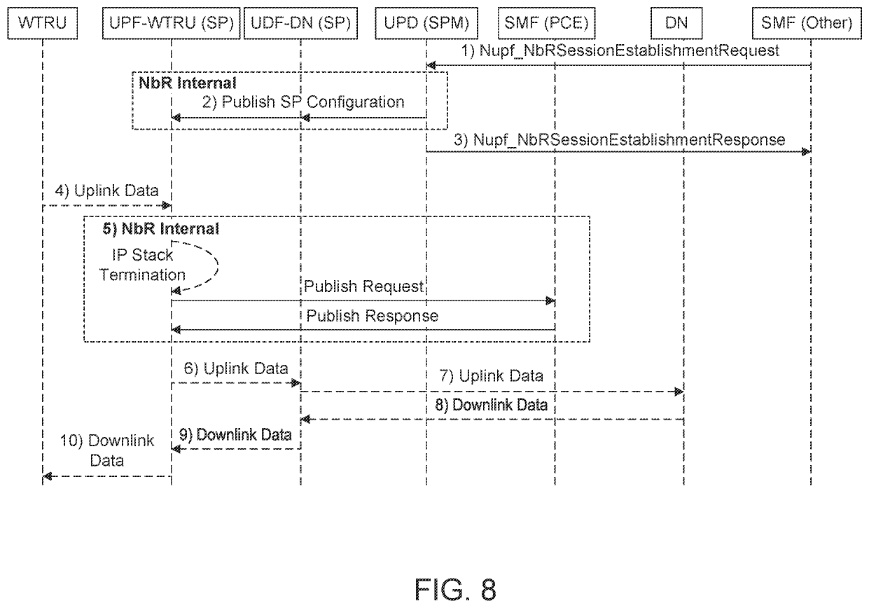

FIG. 8 may be an example of a message exchange in connection with procedures for establishment of a PDU session over an NbR-based user plane in infrastructure mode. Any (e.g. all) step in this section may cover both IP-based and 802.3-based PDU session types and may start with the communication of a session establishment request, by an SMF being any of a part of an (e.g., a proactive) UPF configuration and a part of a PDU session establishment procedure. The message exchange of FIG. 8 may be suitable for a session establishment for NbR UPFs operating in infrastructure mode.

According to Step 1), the consumer (e.g., SMF) may transmit, to the UPFs (e.g., UPF-SPM)) a session establishment request message (e.g., Nupf_NbRSessionEstablishmentRequest( ) message) that may indicate the packet detection rules (PDRs). The SMF (e.g., the consumer) may specify which distributed UPF may receive which set of PDRs utilising the information obtained during the provisioning procedures. This information may be known to the SMF from the provisioning procedures (e.g., as in FIG. 6 and accompanying disclosure) where the UPF properties may define the NbR mode an UPF implements (infrastructure or WTRU).

According to Step 2), the UPF-SPM may transmit to any (e.g., all) SPs (UPF-DN SP, UPF-WTRU SP), the Nupf information for any (e.g., each) UPF, via the NbR-internal signalling pub/sub system.

According to step 3), the UPF-SPM may transmit, to the consumer (e.g., SMF) a session establishment response message (e.g., Nupf_NbRSessionEstablishmentResponse( ) message) that may indicate the status of the session establishment request from Step 1).

According to step 4), the WTRU may (e.g., eventually) receive a confirmation that the PDU session may have been established. The WTRU may be able to transmit uplink data, to the UPF-WTRU SP component, over the user plane.

According to Step 5), The UPF-WTRU SP may apply the NbR methods and procedures to translate IP into ICN, depending on the traffic that arrives, (e.g., any of TLS, HTTP or any other IP-based communication). As part of these procedures, the UPF-WTRU SP may communicate over NbR with the producer (e.g., SMF-PCE) in order to provide the ICN semantics, e.g., rendezvous, and path calculation informing the UPF-WTRU SP about the UPF-DN SP which may be able to serve the request received by the WTRU.

According to Step 6), the UPF-WTRU SP may transmit, to the UPF-DN SP, a message including the uplink data that may be translated (e.g., transparently) for both IP endpoints, into a standard IP-based communication.

According to Step 7), the UPF-DN SP may transmit, to the DN, a message including the uplink data. A vertical application of the DN may process the uplink data request.

According to Step 8), upon the generation of the response to the received request by the WTRU, the vertical application in the DN may transmit to the UPF-DN SP the response of the processed uplink data request using a standard IP-based communication stack.

According to Step 9), the UPF-DN SP may translate the response (e.g., authentication and key agreement (aka) downlink data) into ICN. The UPF-DN SP may transmit, to the UPF-WTRU SP a message including the translated response over an L2 switching structure.

According to Step 10), the UPF-WTRU SP may translate the downlink data back into standard IP-based communication and may transmit, to the WTRU, the translated downlink data via a N3 interface.

### Example of Named-Based-Routing Integration for LAN (WTRU Mode)

The integration of NbR and its support for (e.g., 5G) LAN into a core network (e.g., 5GC) may apply to scenarios where a PDU session type may be Ethernet and a WTRU may transmit 802.3 packet headers with payload on the user plane towards the UPF.

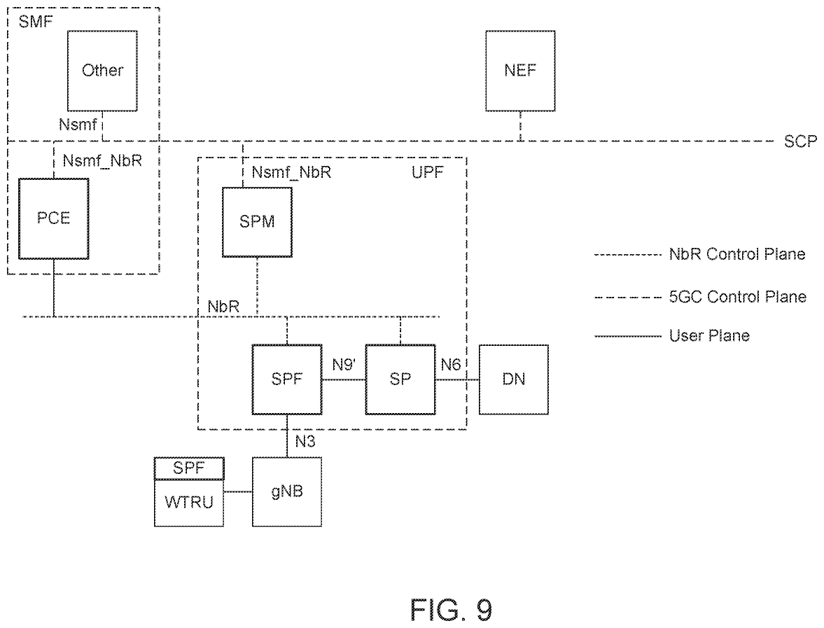

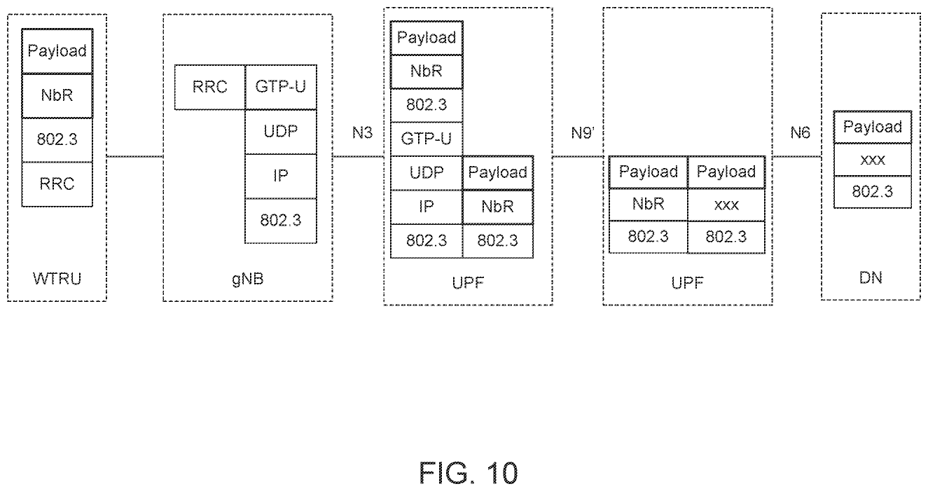

FIG. 9 is a system diagram illustrating examples of an SMF and an UPF of a CN (e.g., 5GC) according to an embodiment. The system of FIG. 10 is similar to the FIG. 5 and has architectural changes concerning the WTRU and UPF communicating to a gNB/WTRU. Other components and interfaces may remain similar to the infrastructure mode described at FIG. 4.

A SP may be located in a WTRU wherein IP traffic may be translated into ICN and vice versa. The SP may communicate over a standard IEEE 802.3 frame header with the UPF. As part of the NbR header in the payload of the ethernet header, additional fields may be included if another WTRU may be the destination.

The path-based forwarding approach NbR may be based on where the PCE may calculate the path through the network based on the pub/sub decision of the PCE which SP may be supposed to be addressed. Procedures for requesting a FID may be processed within the SP. The communication between WTRUs and UPFs may not be part of said FID. A service proxy forwarder (SPF) may be part of the UPF and may perform UPF functionalities according to a N3 interface specification. The SPF component may implement the counterpart of the WTRU procedures.

For example, procedures and methods may be based on an “in-band” NbR control plane communication over an established PDU session (user plane). UPFs that may implement any of the SP and SPF may communicate with each other over IEEE 802.3. Thus, according to FIG. 9, the interface may be annotated as N9′.

FIG. 10 depicts an example of a user plane protocol stack for the WTRU mode. The NbR layer may be extended to the WTRU. The WTRU mode may (e.g., only) support a PDU session type Ethernet. The payload may be any IP-based protocol with NbR offering special service routing capabilities for HTTP (e.g., including TLS-based HTTP communication).

### Example of Session Establishment for WTRU Mode

The session establishment for the WTRU mode may be based on the same assumptions as in the infrastructure mode described at FIG. 8. For example, UPF configurations for N3, N6 and N19 may be communicated via the Nupf interface by SMF while the pub/sub communication for finding a (e.g., the most appropriate) service endpoint that may receive the packet may be communicated in-band.

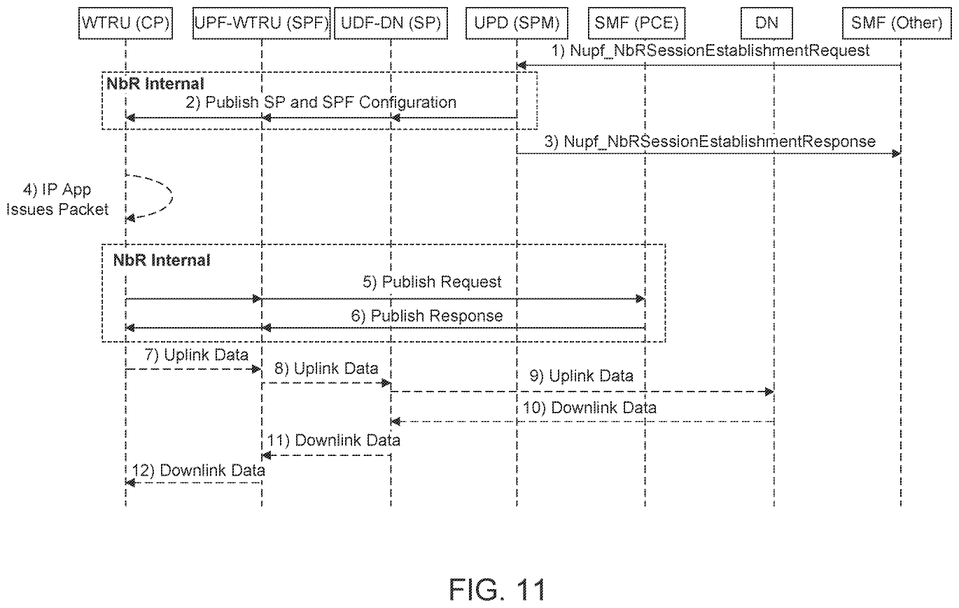

FIG. 11 depicts an example of steps corresponding to a session establishment for NbR UPFs operating in WTRU mode.

According to Step 1), the consumer (e.g., SMF) may transmit, to the UPFs (UPF-SPM) a session establishment request message (e.g., Nupf_NbRSessionEstablishmentRequest( ) message) that may indicate the PDRs. The consumer (e.g., SMF) may indicate which distributed UPF may receive which set of PDRs utilising information obtained during provisioning procedures. For example, in the WTRU mode, the UPF facing the gNB via N3 may be the SPF which may include the MAC address of the WTRU for which a PDU session may be established.

According to Step 2), the SPM (UPF-SPM)) may transmit a message including N4 information to any (e.g., each) SP (UPF-DN SP, WTRU SP) and to any SPF (UPF-WTRU SPF) via the NbR-internal pub/sub signalling system. For example, SPs located on WTRUs (WTRU SPF), may forward information related to NbR control plane procedures, e.g., where to find the PCE (in terms of the FID) for future publish requests. The SPF (UPF-WTRU SPF) may not be able to reach the SP on the WTRU, as the PDU session may have not been configured in any of the gNB and the WTRU. It may be scheduled that the SPF may repeatedly (e.g., periodically) communicate the SPM information towards the WTRU until it (e.g., explicitly) acknowledges it. In another embodiment, the SP of the WTRU may await the PDU session to be established and may (e.g., only) communicate with the SPF via a broadcast IEEE 802.3 frame. SPM information which the SPF holds may be provided to the SPF.

According to Step 3), the UPF-SPM may transmit, to the consumer (e.g., SMF) a session establishment response message (e.g., Nupf_NbRSessionEstablishmentResponse( ) message) that may indicate the status of the session establishment request from Step 1).

According to Step 4, a WTRU application may provide an IP-based communication, such that the SP of the WTRU may (e.g., transparently) intercept any transaction.

According to Step 5) The SP of the WTRU may transmit a message indicating a publish request towards the PCE (SMF-PCE) using the Ethernet PDU session towards the UPF-WTRU SPF with the FID provided by the SPM (UPF (SPM)) in Step 2). The UPF-WTRU SPF may forward the request to the SMF-PCE.

According to Step 6), the SMF-PCE may transmit a message indicating a response with the decision about the request of Step 5) toward the SP of the WTRU via the UPF-WTRU SPF. If a subscriber exists for the IP address or FQDN, the response message for the WTRU SP may include information to reach the destination.

According to Step 7), the WTRU SP may transmit, to the UPF-WTRU SPF a message including uplink data via the Ethernet PDU session. The message including uplink data may be based on the protocol stack of FIG. 10.

According to Step 8), the UPF serving the WTRU (UPF-WTRU SPF) may transmit, to the UPF that serves the DN (UPF-DN SP), a message including the uplink data packet. The IP service endpoint that may handle the transaction by the WTRU may be located in said DN.

According to Step 9), the SP in the UPF-DN SP may translate the payload received by the WTRU back to an IP-based communication. The SP in the UPF-DN SP may transmit, to the DN, a message indicating the transaction.

According to Step 10), the DN may process the request of Step 9). The IP-based application inside the DN may transmit, to the UPF-DN SP, a response message with an IP-based transaction.

According to Step 11), the UPF-DN SP may (e.g., transparently) translate the IP-based traffic into an ICN communication. The UPF-DN SP may transmit, to the UPF-WTRU SPF, a message including a downlink data packet. The transmission of the downlink data packet may be based on the protocol stack of FIG. 10.

According to Step 12), the SPF in the UPF-WTRU SPF may transmit; to the WTRU SP, the downlink data packet over a (e.g., 5G) LAN PDU session. Upon reception of an NbR communication, the SP inside the WTRU may translate the ICN communication transparently back into an IP-based.

### Example of Messages for Nsmf Interface

Nsmf interface that may implement the PCE of the NbR system may include any of the message (e.g., primitive) below.

The Nsmf_NbRSMPolicyControlRequest( ) message (e.g., primitive) may allow any consumer the ability to select the routing policy the PCE may apply for its path calculation. The consumer can specify the namespace and the information item the policy is concerned about. For HTTP-based communication the root namespace may be/http and the information item a (e.g., fully qualified) domain name e.g., as foo.com. The policies envisaged may be based on the assumption that there is more than one subscriber available to the same full qualified domain name (FQDN). Possible policies may include any of shortest path, round robin, and weighted round robin. For example, based on a RESTful realisation of this interface, the HTTP resource POST may be used in a request with java script object notation (JSON) encoded payload.
URL: <FQDN>/session/policy
HTTP Method: POST

Table 1 is an example of a JSON-encoded payload for Nsmf_NbRSMPolicyControlRequest( ) message.

TABLE 1

| Field | Type | Description |
|---|---|---|
| protocol | May be | May be the protocol this policy may be |
| | string | concerned about. |
| identifier | May be | May be based in the protocol selected, |
| | string | the identifier may cover different |
| | | information items, e.g., for HTTP the |
| | | identifier may be an FQDN. |
| policy | May be | The policy which may be applied. The |
| | string | list of possible policies may be |
| | | (e.g., explicitly) known by the |
| | | consumer or may be retrieved via a |
| | | (e.g., given, dedicated) HTTP GET |
| | | request to the URI/policies. The |
| | | response may carry an array of |
| | | protocols and available policies. |

The Nsmf_NbRSMPolicyControlResponse( ) message may describe the response to a Nsmf_NbRSMPolicyControlRequest( ) and may (e.g., only) carry a single JSON-encoded status field. Table 2 is an example of a JSON-encoded payload for Nsmf_NbRSMPolicyControlResponse( ) message.

TABLE 2

| Field | Type | Description |
|---|---|---|
| status_id | May be | May be an integer that may indicate a |
| | integer | successful processing of the request |
| | | (value = 0) or an error (>0). |
| status_msg | May be | If the status_id may not equal 0, this |
| | string | field may provide a human readable |
| | | error message. |

The Nsmf_NbRtopologyRequest( ) message may allow a consumer to request a list of provisioned UPFs and the topology said UPFs form in the format of vertices and edges.
URL: <FQDN>/upf/topology
HTTP Method: GET

The Nsmf_NbRTopologyResponse( ) message may be used to response to any consumer that may have issued a Nsmf_NbRTopologyRequest( ) message. Table 3 is an example of a JSON-encoded payload for Nsmf_NbRTopologyResponse( ) message.

TABLE 3

| Field | Type | Description |
|---|---|---|
| upf_ids | May be | May be an array of unique identifiers for |
| | array<string> | UPFs in form of an EUI-64 address. If |
| | | OVS may be used, the upf_id is the switch |
| | | ID which is derived from one of the |
| | | interfaces MAC addresses. |
| Links | May be | May be an array of edges identified by two |
| | array<string> | UPF IDs in a bidirectional fashion. |

The Nsmf_NbRUpfPropertiesRequest( ) message may allow a consumer to request the properties of a particular UPF using its UPF_ID.
URL: <FQDN>/upf/properties/<UPF_ID>
HTTP Method: GET

The Nsmf_NbRUpfPropertiesResponse( ) message may be used to respond to any consumer that may have issued a Nsmf_NbRUpfPropertiesRequest( ) message. An exemplary JSON-encoded payload may be provided in Table 4 and may serve as a sample of what UPF properties may be useful for consumers.

TABLE 4

| Field | Type | Description |
|---|---|---|
| ports | May be | May be an array of port-related properties |
| | array<string> | such as the port's MAC address, the |
| | | interface name, the link speed, the status |
| | | of the port, among others. |
| hostname | May be | May be an hostname of this UPF. |
| | string | |
| mode | May be | May be the technology mode this UPF |
| | string | supports. For instance, NbR-Infrastructure |
| | | or NbR-UE may be provided. |

### Example of Messages for Nupf Interface

Nupf interface that may implement the SPM component of the NbR system may include any of the message below. The messages (e.g., primitives) below may also argue for a (e.g., general) transitioning of the N4 interface towards a service-based interface utilising HTTP as the application layer protocol and the SCP for service routing among consumers and producers.

The Nupf_NbRFQDNRegistrationRequest( ) message may allow a consumer to register an endpoint against the NbR system using an FQDN.
URL: <FQDN>/fqdn/registration
HTTP Method: POST

Table 5 is an example of a JSON-encoded payload for Nupf_NbRFQDNRegistrationRequest( )

TABLE 5

| Field | Type | Description |
|---|---|---|
| Fqdn | May be | May be the fully qualified domain name of the |
| | string | application under which it will be reachable |
| | | over NbR. |
| endpoint_id | May be | May be an endpoint identifier such as an IP or |
| | string | MAC address. |

The Nupf_NbRFQDNRegistrationResponse( ) message may be a response to a Nupf_NbRFQDNRegistrationRequest( ) message. The response carries an JSON-encoded status message indicating the status of the FQDN registration request. Table 6 is an example of a JSON-encoded payload for Nupf_NbRFQDNRegistrationResponse( ).

TABLE 6

| Field | Type | Description |
|---|---|---|
| status_id | May be | May be an integer that may indicate a |
| | integer | successful processing of the request |
| | | (value = 0) or an error (>0). |
| status_msg | May be | If the status_id may not equal 0, this |
| | string | field may provide a human readable |
| | | error message. |

The Nupf_NbRFQDNRegistrationStatusRequest( ) message may allow a consumer to query the registration stratus of a specific endpoint identifier by any of its IP and MAC address.
URL: <FQDN>/fqdn/registration/status/<ENDPOINT_ID>
HTTP Method: GET

The Nupf_NbRFQDNRegistrationStatusResponse( ) message may be the response to a consumer that had issued a Nupf_NbRFQDNRegistrationStatusRequest( ) message. Table 7 is an example of a JSON-encoded payload for Nupf_NbRFQDNRegistrationStatusResponse( )

TABLE 7

| Field | Type | Description |
|---|---|---|
| fqdn | May be | May be the fully qualified domain name |
| | string | of the application under which it may |
| | | be reachable over NbR. |
| endpoint_id | May be | May be an endpoint identifier |
| | string | (e.g., any of an IP and MAC address). |

The Nupf_NbRSessionEstablishmentRequest( ) message may allow a consumer to communicate N4-related information to an NbR-based UPF using a service-based interface.
URL: <FQDN>/session/establishment
HTTP Method: POST

The UPF identifier obtained from the Nsmf_NbRTopologyRequest( ) message may be used to specify for which UPF the configurations (PDRs) may be meant.

The Nupf_NbRSessionEstablishmentResponse( ) message may be the response to a Nupf_NbRSessionEstablishmentRequest( ) The response may carry an JSON-encoded status message indicating the status of the session establishment request. Table 8 is an example of a JSON-encoded payload for Nupf_NbRSessionEstablishmentResponse( ).

TABLE 8

| Field | Type | Description |
|---|---|---|
| status_id | May be | May be an integer that may indicate a |
| | integer | successful processing of the request |
| | | (value = 0) or an error (>0). |
| status_msg | May be | If the status_id may not not equal 0, this |
| | string | field may provide a human readable |
| | | error message. |

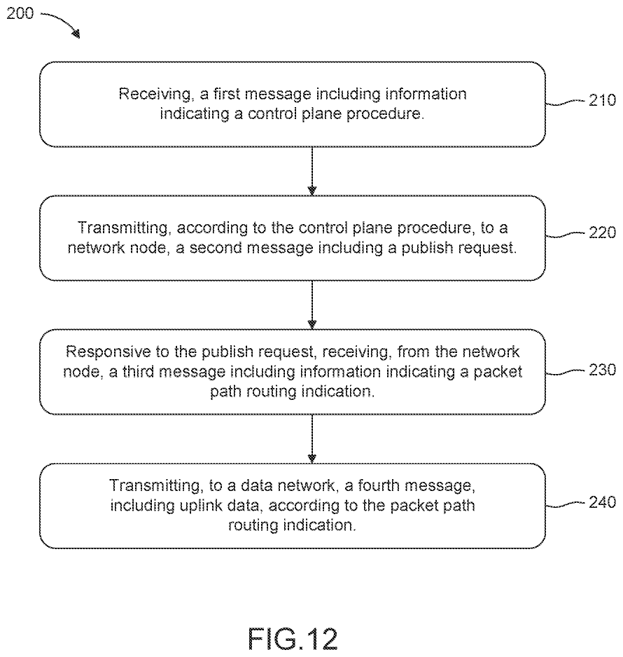

FIG. 12 depicts an example of a method 200 for a session establishment for NbR UPFs operating in WTRU mode according to an embodiment. The method 200 may comprise the following steps.

At step 210, the WTRU may receive a first message including information indicating a control plane procedure. The information indicating the control plane procedure may comprise information indicating at least one of a configuration corresponding to a service proxy and a configuration corresponding to a service proxy forwarder including information indicating a first forwarding identifier for path based packet forwarding toward the data network.

At strep 220, the WTRU may transmit, according to the control plane procedure, to a network node, a second message including a publish request. The second message may comprise the first identifier. The second message may be transmitted to a path computation element of the network node based on the first forwarding identifier. The network node may implement a session management function such that the second message may be transmitted to the session management function of the network node.

At step 230, responsive to the publish request of step 220, the WTRU may receive, from the network node, a third message including information indicating a packet path routing indication. The third message may be received from the session management function of the network node.

At step 240, the WTRU may transmit, to a data network, a fourth message, including uplink data, according to the packet path routing indication. The packet path routing indication may be based on a routing decision relative to the publish request.

The method 200 may further comprise a further step, wherein the WTRU may determine a second forwarding identifier corresponding to the data network based on the packet path routing indication for the uplink data.

The method 200, may further comprise the steps, wherein, responsive to the transmit the fourth message, the WTRU may receive from the data network, a fifth message including downlink data information; and wherein the WTRU may determine at least a source address of the downlink data information based on a third forwarding identifier corresponding to the WTRU. The fifth message may be received via information-centric networking, ICN, protocol.

The first message and the third message may be received by a service proxy of the WTRU. The fourth message may be transmitted via an Ethernet protocol data unit session. The control plan procedure may be a name based-routing control plan procedure.

In an embodiment, a method, implemented by a wireless transmit/receive unit, WTRU, for supporting name-based routing, NbR, on a network, may comprise: receiving, by a service proxy SP of the WTRU, WTRU-SP, from service proxy, SP, of the network, a message including information indicating a NbR control plane procedure; transmitting, from the WTRU-SP, toward a path computation element, PCE, of a session management function, SMF-PCE, of the network, through the SP, a message including a publish request and a forwarding identifier, FID, for a path-based packet forwarding; receiving, by the WTRU-SP, from the SMF-PCE, a message including information indicating a packet path routing indication based on a positive decision relative to the publish request; transmitting, from the WTRU, to a data network, DN, through the SP of the network, a message, including uplink data, via an Ethernet protocol data unit, PDU, session; receiving, by the WTRU, from the DN, through the SP of the network, a message including downlink data information indicating a response of the uplink data, via information-centric networking, ICN, protocol; and translating the ICN communication into IP-based protocol.

In an embodiment, a method, implemented by a user plane function, UPF, of a core network, for performing a name-based routing, NbR, may comprise: receiving, by a service proxy manager, SPM, of the UPF, from a session management function, SMF, of the network, a session establishment request message including information indicating packet detection rules, PDRs, and service-based information; transmitting, from the SPM, to any service proxy, SP, of the UPF, the service-based information; transmitting, from the SPM, to the SMF, a status of the received session establishment request; receiving, by a SP of a wireless transmit/receive unit UPF, UPF-WTRU, from a WTRU, an uplink data packet; translating, by the UPF-WTRU, uplink data packet into information-centric networking, ICN, protocol for path information calculation; transmitting, from the UPF-WTRU, toward a path computation element, PCE, of a session management function, SMF-PCE, of the network, a message including a publish request and a forwarding identifier, FID, for a path-based packet forwarding; receiving, by the UPF-WTRU, from the SMF-PCE, a message including information indicating a packet path routing indication based on a positive decision relative to the publish request; transmitting, by the UPF-WTRU, to a data network UPF, UPF-DN, a message including the uplink data packet translated into IP-based communication; transmitting, from the UPF-DN, to a data network DN, the uplink data packet for a vertical application process; receiving, by the UPF-DN, from the DN, a message including downlink data information indicating a response of the uplink data, via IP-based communication protocol; receiving, by the UPF-WTRU, from the UPF-DN, the message including downlink data information translated into ICN; and transmitting, from the UPF-WTRU, to the WTRU, a message including the downlink data translated into IP-based communication.

In an embodiment, a network architecture configured to perform name-based routing, NbR, may comprise: a path computation element, PCE, integrated in a control plane function, CPF, of the network and comprising a service-based interface, SBI, configured to communicate with a session management function, SMF, of the network; a service proxy manager, SPM, component integrated in a user plane function, UPF, of the network and comprising another SBI, configured to communicate with SMF of the network. The PCE and the SPM may be part of a NbR control plane integrated in the network.

The network architecture may further comprise a service proxy forwarder, SPF, component integrated in the UPF and being part of the NbR control plane, said SPF configured to perform UPF functionalities according to a N3 service-based interface specification and configured to communicate by the SPM to the SMF. The SPF may be configured to forward information related to NbR control plane procedures to WTRU.

While not explicitly described, the present embodiments may be employed in any combination or sub-combination. For example, the present principles are not limited to the described variants, and any arrangement of variants and embodiments can be used.

Besides, any characteristic, variant or embodiment described for a method is compatible with an apparatus device including means for processing the disclosed method, with a device comprising a processor configured to process the disclosed method, with a computer program product comprising program code instructions and with a non-transitory computer-readable storage medium storing program instruction.

### REFERENCES

The following references may have been referred to hereinabove and are incorporated herein by reference in their entirety:
[1] U.S. Pat. No. 10,554,553; and
[2] U.S. Patent Application Publication No. 2020/0162573.

### CONCLUSION

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to any of, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in any of a WTRU, UE, terminal, base station, RNC, and any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the representative embodiments are not limited to the above-mentioned platforms or CPUs and that other platforms and CPUs may support the provided methods.

The data bits may also be maintained on a computer readable medium including magnetic disks, optical disks, and any other volatile (e.g. RAM) or non-volatile (e.g. ROM) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (e.g., but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any UE recited herein, are provided below with respect to FIGS. 1A-1D.

In certain representative embodiments, several portions of the subject matter described herein may be implemented via application specific integrated circuits (ASICs), field programmable gate arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of” multiples of the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U. S.C. § 112, ¶6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, mobility management entity (MME) or evolved packet core (EPC), or any host computer. The WTRU may be used m conjunction with modules, implemented in hardware and/or software including a software defined radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a near field communication (NFC) module, a liquid crystal display (LCD) display unit, an organic light-emitting diode (OLED) display unit, a digital music player, a media player, a video game player module, an Internet browser, and/or any Wireless local area network (WLAN) or ultra wide band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

1. A method, implemented by a wireless transmit/receive unit (WTRU) the method comprising:
receiving, from a network node, a first message including first information indicating a control plane procedure, wherein the first information comprises second information indicating at least one of a first configuration corresponding to a service proxy and a second configuration corresponding to a service proxy forwarder, and wherein the second configuration comprises third information indicating a first forwarding identifier for path based packet forwarding toward the network node;
transmitting, based on the control plane procedure, to the network node, a second message including a publish request;
responsive to the publish request, receiving, from the network node, a third message including fourth information indicating a second forwarding identifier; and
transmitting a fourth message including uplink data to a data network (DN), wherein the fourth message is transmitted according to a packet path routing indication based on the second forwarding identifier.

2. (canceled)

3. The method according to claim 1, wherein the second message comprises the first forwarding identifier.

4. The method according to claim 1, comprising transmitting the second message to a path computation element of the network node based on the first forwarding identifier.

5. The method according to claim 1 comprising transmitting the second message to a path computation element of the network node.

6. The method according to claim 1, wherein the packet path routing indication is based on a routing decision, wherein the routing decision is responsive to the publish request.

7. The method according to claim 1, wherein the second forwarding identifier corresponds to the DN, the method further comprising:
determining the second forwarding identifier based on the packet path routing information for the uplink data.

8. The method according to claim 1, wherein the WTRU is a first WTRU, the method further comprising:
receiving from the data network, a fifth message including downlink data information, wherein the downlink data information indicates a response to the uplink data; and
determining at least a source address of the downlink data information based on a third forwarding identifier corresponding to a second WTRU that originated of the downlink data.

9. (canceled)

10. The method according to claim 1, wherein the first message and the third message are received by a service proxy of the WTRU.

11. The method according to claim 1, wherein the transmission of the fourth message is a transmission via an Ethernet protocol data unit session.

12. The method according to claim 1, wherein the control plan procedure is a name based-routing control plan procedure.

13. A wireless transmit/receive unit (WTRU) comprising circuitry, including a transmitter, a receiver, a processor and memory, and configured to:
receive, from a network node, a first message including first information indicating a control plane procedure, wherein the first information comprises second information indicating at least one of a first configuration corresponding to a service proxy and a second configuration corresponding to a service proxy forwarder, and wherein the second configuration comprises third information indicating a first forwarding identifier for path based packet forwarding toward the network node;
transmit, based on the control plane procedure, to the network node, a second message including a publish request;
responsive to the publish request, receive, from the network node, a third message including fourth information indicating a second forwarding identifier; and
transmit a fourth message including uplink data to a data network (DN), wherein the fourth message is transmitted according to a packet path routing indication based on the second forwarding identifier.

14. (canceled)

15. The WTRU of claim 13, wherein the second message comprises the first forwarding identifier.

16. The WTRU according to claim 13, configured to transmit the second message to a path computation element of the network node based on the first forwarding identifier.

17. The WTRU according to claim 13, configured to transmit the second message to a path computation element of the network node.

18. The WTRU according to claim 13, wherein the packet path routing indication is based on a routing decision, wherein the routing decision is responsive to the publish request.

19. The WTRU according to claim 13, wherein the second forwarding identifier corresponds to the DN, and the WTRU is configured to:
determine the second forwarding identifier based on the packet path routing information for the uplink data.

20. The WTRU according to claim 13, wherein the WTRU is a first WTRU, and the first WTRU is configured to:
receive from the data network, a fifth message including downlink data information, wherein the downlink data information indicates a response to the uplink data; and
determine at least a source address of the downlink data information based on a third forwarding identifier corresponding to a second WTRU that originated the downlink data.

21. (canceled)

22. The WTRU according to claim 13, wherein the first message and the third message are received by a service proxy of the WTRU.

23. The WTRU according to claim 13, wherein the transmission of the fourth message is a transmission via an Ethernet protocol data unit session.

24. The WTRU according to claim 13, wherein the control plan procedure is a name based-routing control plan procedure.
